(19) United States
(12) Patent Application Publication
(10) Pub. No.: US 2007/0005379 A1
(43) Pub. Date: Jan. 4, 2007

(54) Scale with auto identification of frequently weighed items

(76) Inventors: Santos Juan-Castellanos, Springfield, OH (US); Lawrence A. Pevoar, Miamisburg, OH (US)

Correspondence Address: THOMPSON HINE LLP, P.O Box 8801, DAYTON, OH, 45401-8801, US

(21) Appl. No.: 11/169,449

(22) Filed: Jun. 29, 2005

(51) Int. Cl. G06Q 99/00

(52) U.S. Cl. 705/1

(57) ABSTRACT

A scale and associated methods automatically identify most frequently weighed food items for displaying the most frequently weighed food items on a display.

### TECHNICAL FIELD

The present application relates generally to scales used to weigh food products in supermarkets, and more particularly to a scale that identifies frequently weighed items.

### BACKGROUND

Scales have been used in stores such as supermarkets and groceries to weigh and price food items and to generate a pricing label for such food items. In order to price any food item of the many possible food item selections, the scales may allow for user selection of a food item from a list or menu of all possible food items within a store or store department. This list or menu can be cumbersome to navigate. In some instances, a scale may allow for user entry of product identifying information to identify a particular product.

### SUMMARY

In one aspect, in connection with a food product scale located in a store where the scale includes a weighing station having an associated mechanism for producing weight indicative signals and user interface includes at least one display, a method of presenting a variety of food products to a user to facilitate weighing operations is provided. The method includes tracking food product weighing operations of the scale to identify frequency of weighing for each of a plurality of food products. Based upon the tracking step, a first multiplicity of food products are identified to be displayed on a first user interface screen. A second multiplicity of food products are identified to be displayed on a second user interface screen. The identification of the first multiplicity of food products is based upon most frequently weighed food products during a first time period and the identification of the second multiplicity of food products is based upon most frequently weighed food products during a second time period. The first user interface screen is presented with the first multiplicity of food products to users via the display during the first time period and the second user interface screen is presented with the second multiplicity of food products to users via the display during the second time period.

In another aspect, in connection with a food product scale located in a store where the scale includes a weighing station having an associated mechanism for producing weight indicative signals and a user interface includes at least one display, a method of presenting a variety of food products to a user to facilitate weighing operations is provided. The method includes tracking food product weighing operations of the scale to identify frequency of weighing for each of a plurality of food products. Based upon the tracking step, a first multiplicity of food products are identified to be displayed on a first user interface screen and a second multiplicity of food products are identified to be displayed on a second user interface screen for the display. The identification of the first multiplicity of food products is based at least in part upon most frequently weighed food products during a first scale mode and the identification of the second multiplicity of food products is based at least in part upon most frequently weighed food products during a second scale mode. The first user interface screen is presented with the first multiplicity of food products to users via the display during the first scale mode and the second user interface screen is presented with the second multiplicity of food products to users via the display during the second scale mode.

In another aspect, a scale for use in weighing food products includes a weighing station for receiving food products to be weighed. The weighing station has an associated mechanism for producing weight indicative signals. A controller receives weight indicative signals from the mechanism. The controller is operable to establish a price for a weighed food product based in part upon a weight indicative signal produced for that food product. A user interface is provided that includes at least one display. The controller is connected with the display for controlling the display of food product designators. The controller is operable to track food product weighing operations of the scale, specifically frequency of weighing for a plurality of food products. The controller is further operable to identify a plurality of sets of food products where each set of food products is identified for display on a respective user interface screen. The identification of each set of food products is based upon most frequently weighed food products during a respective time period for the set. The controller is further operable to permit the respective time period to be selected manually at the scale via the user interface.

### BRIEF DESCRIPTION OF THE DRAWINGS

FIG. 1 is a perspective view of an exemplary food product scale;

FIG. 2 is a schematic view of the scale of FIG. 1;

FIG. 3 is a flow diagram of an embodiment of a method for presenting a variety of food products to a user; and

FIGS. 4a and 4b are schematic views of exemplary interface screens presented on the scale display.

### DETAILED DESCRIPTION

Referring to FIG. 1 an exemplary scale 10 is shown including a weigh station 12 and a display 14. Weigh station 12 may take the form of a platter-type member supported in relationship to a load cell (internal of the scale housing) that produces a weight indicative signal when a food item is placed on the weigh station 12 for weighing. Illustrated display 14 may take the form of an LCD-type display, but other technologies could be used. In the illustrated embodiment the display 14 is a touch screen-type display that also functions as a user input device 16 by displaying buttons/icons 18 that can be triggered by a user. The buttons/icons 18 allow for user selection of an item to be weighed from a menu or group 21 of items 23 presented to the user by display 14. The displayed group 21 of items 23 may be pre-selected based on selected parameters. A separate user input device could also be provided, for example, in the form of manually activated keys/buttons located alongside the display 14. A side portion 20 of the scale housing holds a label printer and associated supply of labels, which are dispensed through a label slot 22 in the housing. Although display screen 14 is shown incorporated into the housing of the scale 10, the display could take the form of a marquee-type display located on a support extending upward from the scale housing.

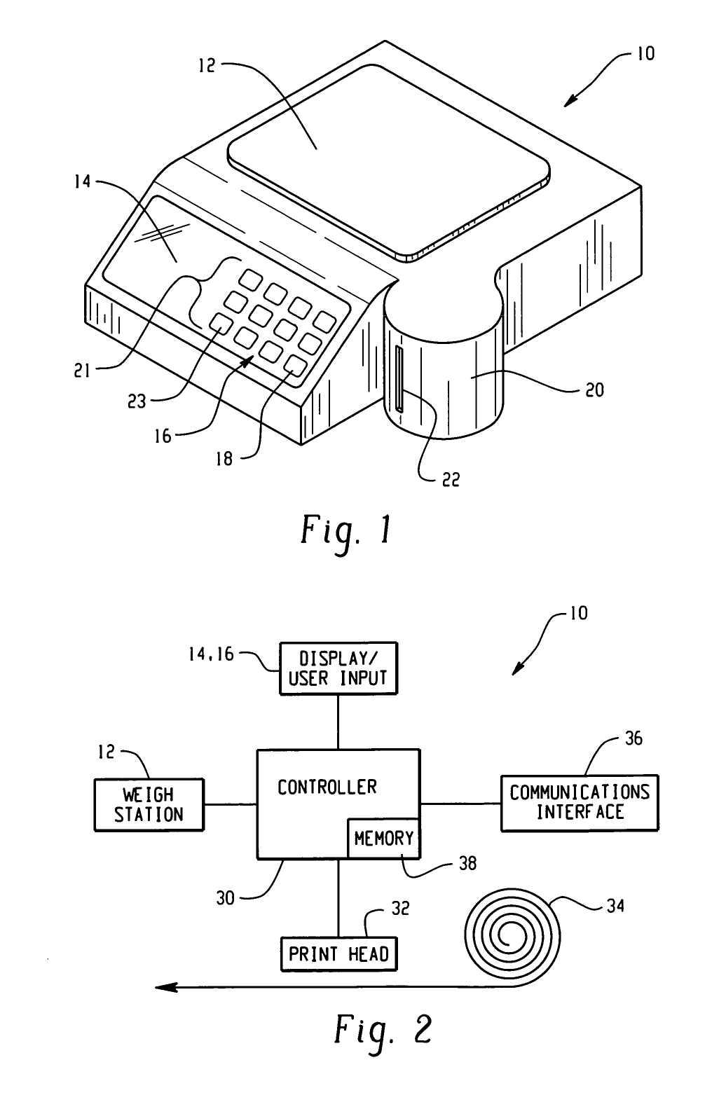

Referring now to FIG. 2, an exemplary schematic of the scale 10 is shown. The scale includes a controller 30, such as a microprocessor based unit, connected to control the display 14 and user input 16 and connected to receive weight indicative signals from the weighing station 12. A print head 32 and associated supply of label stock 34 that can be moved past the print head 32 is also shown. In one example the print head 32 may be a thermal print head for use with thermally activated label stock. However, other types of printing technologies and label media could also be used. The controller 30 is also connected with a communications interface 36, which may take the form of a standard connector (and associated circuitry) for a USB, RS-232, Ethernet or other hard-wired communication line. In another example the communications interface 36 may be formed by a wireless communication device such as an RF transceiver. The illustrated controller 30 includes associated memory 38 for storing product information.

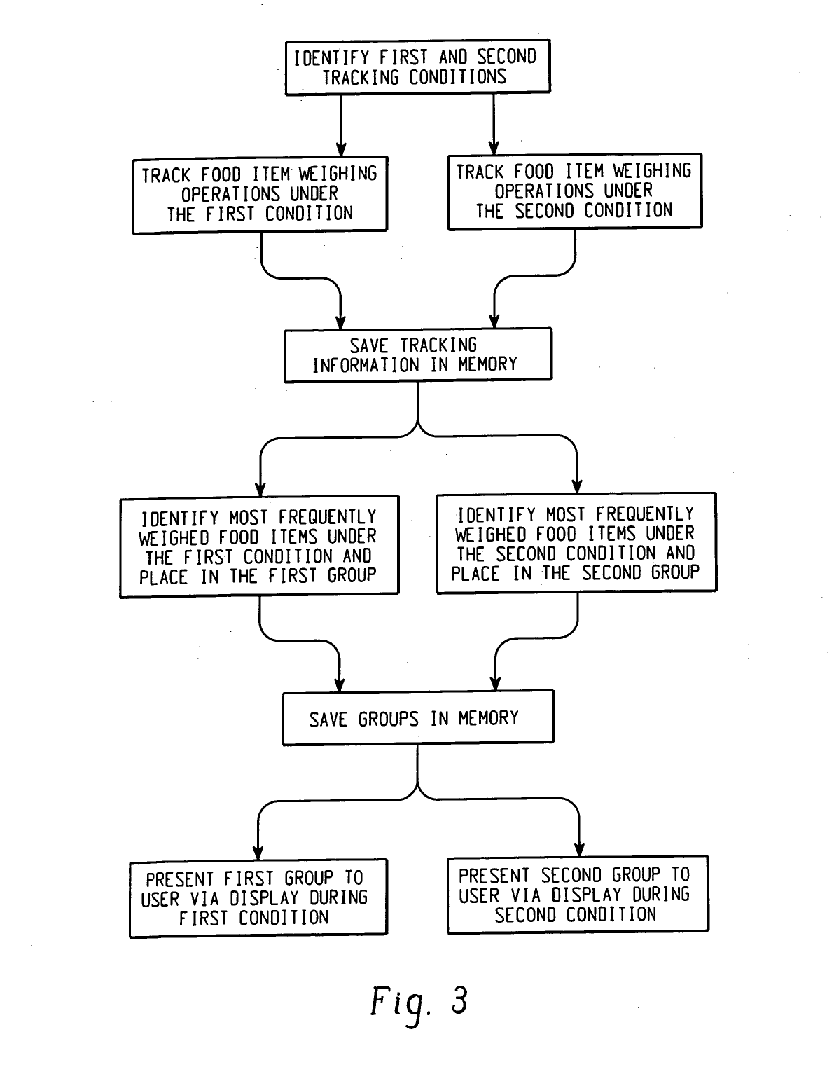

Referring also to FIG. 3, the controller 30 or other processor-based unit is used to track weighing operations of the scale 10. For example, the controller 30 can track food weighing operations to determine the frequency of weighing for food products and this data can be saved in memory 38. In some cases, the frequency of weighing can be continually tracked throughout operation of the scale 10 (in other words, on an ongoing basis). Alternatively, the frequency of weighing may be tracked for only a certain period of time, which may be associated with, for example, an initialization period, a seasonal period, or even certain months or month of a year, certain weeks or week of a month, certain days or day of a week, certain hours or hour of a day, or the frequency of weighing may be tracked based on other parameters such as from daybreak to dusk, from dusk to dawn, etc.

Based on the tracking information, the controller 30 can select a number of most frequently weighed food items that can be associated together as a group in memory 38. For example, a flag in a food item record can be set to reflect that the food item is part of a group. In some embodiments, controller 30 selects multiple groups of most frequently weighed food items under multiple, differing conditions where a particular group of most frequently weighed food items occurs under a particular condition. For example, controller 30 may select a first group of most frequently weighed food items during a first time period and may select a second group of most frequently weighed food items during a second time period that is different from the first time period. Food item selection for the first and second groups can be based on tracking data indicating the number of weighing operations performed on food items during previous time periods similar or identical to the first and second time periods and saved in memory 38. The first group may include a particular food item and the second group may or may not include that particular food item. Examples of time periods used as conditions for group selection include a portion of a seven day period, a day, a portion of a 24-hour period, an hour, etc. In some instances, a first time period and a second time period may be selected to cumulatively complete a selected time period such as a 24-hour time period. Once a group of most frequently weighed food items has been determined for a selected time period, that group of most frequently weighed food items can be displayed to a user or customer during that time period to allow for relatively easy selection of that food item from the display 14 to complete a weighing operation.

Scale 10 may select for display a group of most frequently weighed food items during a particular scale mode. In some cases, scale 10 may select multiple groups of most frequently weighed food items during multiple, differing scale modes. For example, controller 30 may select a first group of most frequently weighed food items for display during a first scale mode and may select a second group of most frequently weighed food items for display during a second scale mode that is different from the first scale mode. Food item selection for the first and second groups can be based on tracking data indicating the number of weighing operations performed on food items during previous occasions with the scale 10 in the respective first and second scale modes and the resulting data can be saved in memory 38. Examples of scale modes during which weighing operations may be tracked include language modes such as English and Spanish language modes (which may be initiated by user selection of a preferred language) and a first customer mode triggered by identification of a first customer and a second customer mode triggered by identification of a second customer different from the first customer (where customer identification may be achieved by having the customer manually enter a customer specific number or by including a customer identification reader into the scale).

For tracking (and/or pricing) purposes, food items can be identified to the controller 30 via the user input device 16. For example, the user may input a product lookup (PLU) number assigned to the product. In another example, the display 14 may generate a list of food products or a series of pictures of food products from which the user can select. In still another example, the scale 10 may include technology, such as vision technology or RFID technology, enabling the scale to identify the food product merely from its placement on the weighing station.

Once a sample of tracking data has been received, e.g., for any or all of the above described conditions or any other desirable conditions not described above, the sample is used to determine those food items most frequently weighed under selected conditions. The group may be limited to a certain number of food items, such as five, ten, 20, 30, 50, 100 or more. As another example, the number of food items in a group may be limited to all (or only some of) those food items undergoing a certain number or more weighing operations under the particular condition, such as 10 or more, 50 or more, 100 or more, 1000 or more, etc. Any suitable method may be used to select a group of most frequently weighed food items for a given condition using the collected tracking data. It may even be desirable to exclude certain food items even if they are one of the most frequently weighed food items under a given condition. For example, it may be desirable to exclude a seasonal food item once the season is over even though the seasonal food item may have been a most frequently weighed food item during the season.

As noted above, weighing operations can be tracked continuously, on an on-going basis or they can be tracked periodically. Food items once determined to be a most frequently weighed food item under a selected condition may be removed from the group, for example, due to a decrease in performed weighing operations and may be replaced by a different food item not originally in the group, accounting for, e.g., trends in food item popularity. Food items may reside in multiple groups. In other words, a food item may be a most frequently weighed food item under more than one condition, such as both in the morning and in the evening, such as among both English-speaking customers and Spanish-speaking customers.

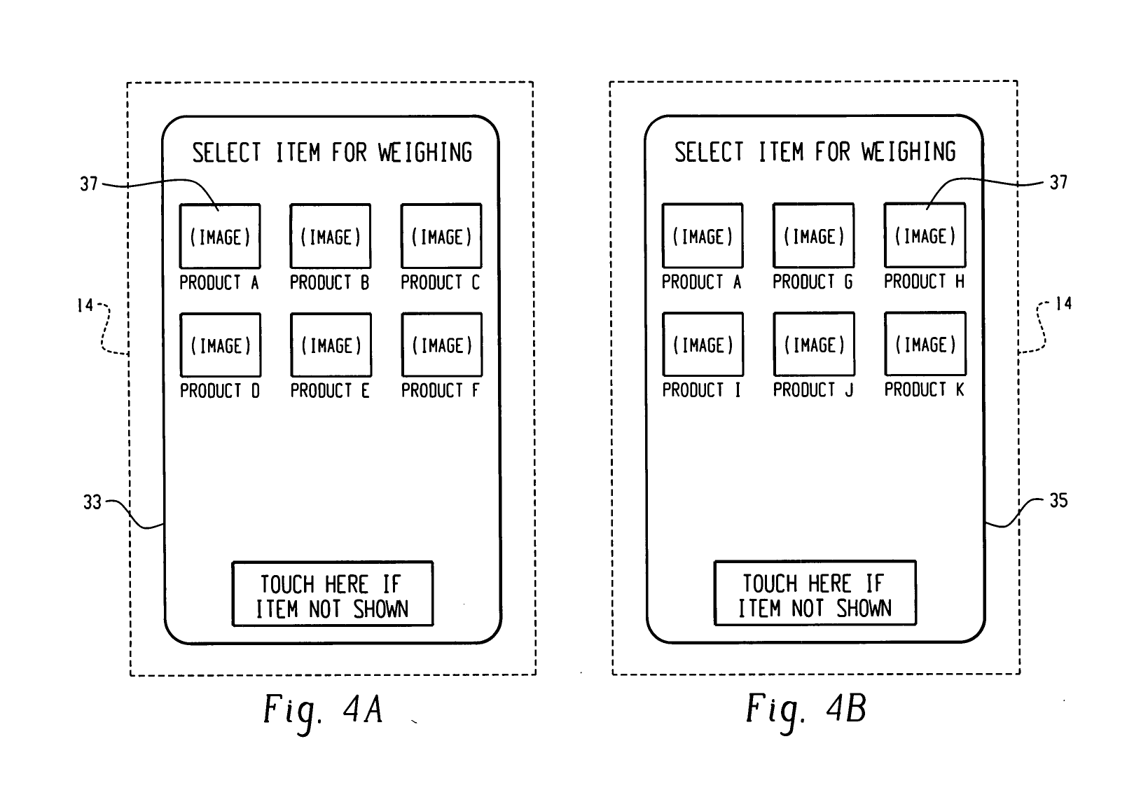

Referring now to FIGS. 4a and 4b, an interface screen 33 and an interface screen 35 are shown in connection with the display 14. As presented on display 14, interface screen 33 includes graphics 37 (e.g., pictures, illustrations and/or text such as names) of those food items that have been determined by controller 30 (FIG. 2) to be those most frequently weighed under a first condition (e.g., first time period, first scale mode, etc.) and interface screen 35 includes graphics 37 of those food items that have been determined to be those most frequently weighed under a second condition (e.g., second time period, second scale mode, etc.) different from the first condition. The interface screens 33 and 35 are presented to users via display 14 at different times, specifically with the scale 10 operating under the respective first and second conditions associated with the first and second interface screens. To illustrate by example, interface screen 33 may include food items that have been determined to be those most frequently weighed between 12:00 pm and 11:59 pm (e.g, based upon past weighing operations during that time period), while interface screen 35 may include food items that have been determined to be those most frequently weighed between 12:00 am and 11:59 am (e.g., based upon past weighing transactions during that time period). Interface screen 33 can be displayed by display 14 between 12:00 pm and 11:59 pm and interface screen 35 can be displayed between 12:00 am and 11:59 am. Thus, at 12:00 am the controller of the scale would operate to switch from interface screen 33 to interface screen 35, with the items displayed on the “new” or “changed” interface screen 35 being determined by the past weighing operations for the 12:00 am to 11:59 am time period.

In some embodiments, scale 10 may be configured to present more than two interface screens (e.g., three, four, five, six, seven, eight, nine, ten or more different interface screens) on display 14 during respective different conditions of the scale (e.g., one interface screen for each day of the week where each screen displays those most frequently weighed items during its respective day). In one embodiment, a language mode of the scale may be used to establish most frequently weighed items, such that during English language mode the presented interface screen includes graphics 37 of food items that have been determined to be those most frequently weighed with the scale in an English mode and during Spanish language mode the presented interface screen includes graphics 37 of food items most frequently weighed with the scale in a Spanish mode. In some embodiments, an interface screen may display most frequently weighed food items under a combination of conditions (e.g., both language mode and time periods may be used as combined conditions to establish most frequently weighed items). Further, customer identity (as entered by a customer pin number or by scanning of a customer ID device) may be used as a condition for establishing most frequently weighed items.

By displaying the most frequently weighed food items for the user or customer, weighing operations can be simplified which can reduce the amount of time necessary to complete a weighing operation, for example, to price an food item for purchase. The user or customer can simply select the food item from the display of a relatively limited number of food items to identify the food item as opposed to manually keying the food item into the user interface or selecting the food item from a relatively voluminous list of product. If only the most frequently weighed food items are displayed for user selection from the user interface, there is a high probability that the food item has been selected as part of the group being displayed. It should be noted, however, that depending on the selected conditions, number of items displayed, customer purchasing habits, etc., the probability that the food item has been selected as part of the group being displayed may not be high. In some embodiments, if the food item is not displayed, i.e., the food item is not one of those most frequently weighed under the particular conditions, the user can enter an identifier for the food item using the user interface or select the food item from a more voluminous menu of food items. This selection can be tracked by the scale 10 and saved into memory 38 and, in some cases, used to create an updated grouping of most frequently selected items.

Referring back to FIG. 2, after the food product is identified to the controller 30, the controller 30 then retrieves from memory 38 price information for the identified food product and calculates a price for the item based upon its weight. Additionally, some food items may be priced according to count, in which case the user also identifies to the controller 30 the count so that the controller can calculate price from the count. Once price is calculated, the controller effects printing of a pricing label for the weighed product so that the pricing label can be applied to the product. Such label printing may be automated or may be triggered through the user input 16. Notably, information in addition to price may also be retrieved from memory 38 for the purpose of defining the label that is printed. Scale pricing operations are described in greater detail in pending U.S. patent application Ser. No. 10/922,495, filed Aug. 20, 2004 the details of which are hereby incorporated by reference as if fully set forth herein.

It is to be clearly understood that the above description is intended by way of illustration and example only and is not intended to be taken by way of limitation. Other changes and modifications could be made.

What is claimed is:

1. In connection with a food product scale located in a store, the scale including a weighing station having an associated mechanism for producing weight indicative signals, and a user interface including at least one display, a method of presenting a variety of food products to a user to facilitate weighing operations, the method comprising the steps of:
tracking food product weighing operations of the scale to identify frequency of weighing for each of a plurality of food products;
based upon the tracking step, identifying a first multiplicity of food products to be displayed on a first user interface screen and identifying a second multiplicity of food products to be displayed on a second user interface screen, the identification of the first multiplicity of food products is based upon most frequently weighed food products during a first time period and the identification of the second multiplicity of food products is based upon most frequently weighed food products during a second time period; and
presenting the first user interface screen, with the first multiplicity of food products, to users via the display during the first time period;
presenting the second user interface screen, with the second multiplicity of food products, to users via the display during the second time period.

2. The method of claim 1 wherein the first time period is a portion of a seven day period and the second time period is a different portion of the seven day period.

3. The method of claim 2 wherein the first time period is one day and the second time period is one day.

4. The method of claim 1 wherein the first time period is a portion of a 24 hour period and the second time period is a different portion of the 24 hour period.

5. The method of claim 4 wherein the first time period is one hour and the second time period is one hour.

6. The method of claim 4 wherein the first time period and the second time period cumulatively complete the 24 hour time period.

7. The method of claim 1 wherein the identifying step includes identifying third, fourth, fifth, sixth and seventh multiplicities of food products for respective third, fourth, fifth, sixth and seventh user interface screens, each of the seven multiplicities identified based upon most frequently weighed items for a respective day of the week, and each of the seven user interface screens is presented, on the display, on its respective day of the week.

8. The method of claim 1 wherein the first user interface screen is presented with a picture of each of the first multiplicity of food products and the second user interface screen is presented with a picture of each of the second multiplicity of food products.

9. The method of claim 1 wherein the first user interface screen is presented with a name of each of the first multiplicity of food products and the second user interface screen is presented with a name of each of the second multiplicity of food products.

10. The method of claim 1 comprising the further steps of adjusting the first time period, adjusting the second time period and repeating the steps of claim 1.

11. In connection with a food product scale located in a store, the scale including a weighing station having an associated mechanism for producing weight indicative signals, and a user interface including at least one display, a method of presenting a variety of food products to a user to facilitate weighing operations, the method comprising the steps of:
tracking food product weighing operations of the scale to identify frequency of weighing for each of a plurality of food products;
based upon the tracking step, identifying a first multiplicity of food products to be displayed on a first user interface screen and identifying a second multiplicity of food products to be displayed on a second user interface screen for the display, the identification of the first multiplicity of food products is based at least in part upon most frequently weighed food products during a first scale mode and the identification of the second multiplicity of food products is based at least in part upon most frequently weighed food products during a second scale mode; and
presenting the first user interface screen, with the first multiplicity of food products, to users via the display during the first scale mode;
presenting the second user interface screen, with the second multiplicity of food products, to users via the display during the second scale mode.

12. The method of claim 11 wherein the first scale mode is a first language mode of the scale and the second scale mode is a second language mode of the scale.

13. The method of claim 11 wherein the first language mode is an English language mode and the second language mode is a Spanish language mode.

14. The method of claim 11 wherein the first scale mode is a first customer mode triggered by identification of a first customer, and the second scale mode is a second customer mode triggered by identification of a second customer.

15. A scale for use in weighing food products, comprising:
a weighing station for receiving food products to be weighed, the weighing station having an associated mechanism for producing weight indicative signals;
a controller for receiving weight indicative signals from the mechanism, the controller operable to establish a price for a weighed food product based in part upon a weight indicative signal produced for that food product;
a user interface including at least one display, the controller connected with the display for controlling the display of food product designators;
wherein the controller is operable to track food product weighing operations of the scale, specifically frequency of weighing for a plurality of food products, and the controller is further operable to identify a plurality of sets of food products, each set of food products identified for display on a respective user interface screen, the identification of each set of food products is based upon most frequently weighed food products during a respective time period for the set; and
wherein the controller is further operable to permit the respective time period to be selected manually at the scale via the user interface.
